(19) United States
(12) Patent Application Publication
(10) Pub. No.: US 2017/0022342 A1
(43) Pub. Date: Jan. 26, 2017

(54) GAS BARRIER FILM AND MANUFACTURING METHOD THEREFOR

(71) Applicant: SAMSUNG SDI CO., LTD., Yongin-si Gyeonggi-do (KR)

(72) Inventors: Byung Soo KIM, Uiwang-si (KR); Se Yeong KANG, Uiwang-si (KR); Joong In KIM, Uiwang-si (KR); Dae Gyu LEE, Uiwang-si (KR); Woo Suk CHOI, Uiwang-si (KR)

(21) Appl. No.: 15/039,355

(22) PCT Filed: Nov. 10, 2014
(86) PCT No.: PCT/KR2014/010747

§ 371 Date: May 25, 2016

(30) Foreign Application Priority Data
Nov. 29, 2013 (KR) 10-2013-0147956

(51) Int. Cl. C08J 7/04; B29C 71/02; C09D 183/14; C08J 7/12

(52) U.S. Cl. CPC C08J 7/047; C08J 7/123; C08J 7/08; C09D 183/14; C08J 2483/14; C08J 2367/02

(57) ABSTRACT

The present invention relates to a gas barrier film and a manufacturing method therefor, the gas barrier film comprising: a base; and a barrier layer formed on one surface of the base, wherein the barrier layer has a nitrogen (N) atomic percent of about 1% to about 6%. The gas barrier film, according to the present invention, has an excellent gas barrier property, scratch resistant property, flexibility, transparency and crack prevention effect, and the method for manufacturing the same can be performed by non-vacuum wet coating, and thus a manufacturing time is short, and process performance is excellent.

### TECHNICAL FIELD

The present invention relates to a gas barrier film and a method for manufacturing the same.

### BACKGROUND ART

Conventionally, pane glass is generally used as an electrode substrate for liquid crystal display panels, and display members of plasma displays, electroluminescent (EL) displays, fluorescent display boards, and light emitting diodes. However, pane glass is likely to be damaged, has no flexibility, and has high specific gravity and a limit in reduction of thickness and weight thereof. To solve such problems, plastic films have attracted attention as a material for replacing pane glass in the related art. Plastic films are light, not fragile and allow easy reduction in thickness, and are thus used as materials capable of effectively coping with size increase of display devices.

However, since plastic films have higher gas permeability than glass, a display device using a plastic film in a substrate is vulnerable to infiltration of oxygen or vapor, causing deterioration in luminous efficacy of the display device. Accordingly, attempts have been made to minimize influence of oxygen or vapor by forming gas barrier films of an organic or inorganic material on the plastic film. As such gas barrier films, inorganic materials such as silicon oxide (SiOx), aluminum oxide (AlxOy), tantalum oxide (TaxOy), and titanium oxide (TiOx) are mainly used. Such gas barrier films are coated onto a surface of the plastic film through vacuum deposition, such as plasma enhanced chemical vapor deposition (PECVD) and sputtering, or a sol-gel process under a high vacuum.

Japanese Patent No. 1994-0031850 and No. 2005-0119148 disclose a plastic film which includes an inorganic layer directly coated onto a surface thereof by sputtering. In this case, however, since the plastic film and the inorganic layer are significantly different in terms of coefficient of elasticity, coefficient of thermal expansion, radius of curvature, and the like, cracks are created at an interface therebetween due to stress resulting from bending or application of heat or repetitive force from outside, thereby causing easy delamination of the inorganic layer from the plastic film. Further, Japanese Patent No. 2004-0082598 discloses a multi-layered barrier film composed of organic and inorganic layers. However, also in this case, several layers having different properties are present, causing increase in risk of cracking at respective interfaces and delamination of the film.

Moreover, since a typical gas barrier film is formed through deposition under high vacuum, expensive equipment is required and high vacuum degree requires evacuation for a long period of time, thereby causing economic infeasibility.

### DISCLOSURE

### Technical Problem

It is one aspect of the present invention to provide a gas barrier film which has excellent gas barrier performance.

It is another aspect of the present invention to provide a gas barrier film which exhibits excellent properties in terms of flexibility and crack prevention.

It is a further aspect of the present invention to provide a gas barrier film which has excellent scratch resistance.

It is yet another aspect of the present invention to provide a method for manufacturing a gas barrier film which allows non-vacuum wet coating, thereby shortening fabrication time and providing excellent processability.

It is a yet further aspect of the present invention to provide a flexible display which includes the gas barrier film as set forth above.

### Technical Solution

One aspect of the present invention relates to a gas barrier film which includes a substrate and a barrier layer formed on one surface of the substrate, wherein the barrier layer has a nitrogen (N) atom concentration of about 1 atomic percent (at %) to about 6 at %.

Another aspect of the present invention relates to a method for manufacturing a gas barrier film including: coating a coating solution including hydrogenated polysilazane or hydrogenated polysiloxazane onto one surface of a substrate; UV curing; and high humidity aging at about 70% to about 90% RH to form a barrier layer having a nitrogen atom concentration of about 1 at % to 6 at %.

A further aspect of the present invention relates to a flexible display having the gas barrier film as set forth above formed on a flexible substrate.

### Advantageous Effects

The present invention provides a gas barrier film which has excellent gas barrier performance and exhibits excellent properties in terms of scratch resistance, transparency, flexibility, and crack prevention, and a method for manufacturing the same which allow non-vacuum wet coating, thereby shortening fabrication time and providing excellent processability.

### DESCRIPTION OF DRAWINGS

FIG. 1 is a schematic sectional view of a gas barrier film according to one embodiment of the present invention.

### BEST MODE

Hereinafter, embodiments of the present invention will be described in detail with reference to the accompanying drawings. It should be understood that the present invention is not limited to the following embodiments and may be embodied in different ways, and that the following embodiments are given to provide complete disclosure of the invention and to provide a thorough understanding of the invention to those skilled in the art. It should be noted that the drawings are not to precise scale and some of the dimensions, such as width, length, thickness, and the like, are exaggerated for clarity of description in the drawings. Although some elements are illustrated in the drawings for convenience of description, other elements will be easily understood by those skilled in the art. It should be noted that all the drawings are described from the viewpoint of the observer. It will be understood that, when an element is referred to as being on another element, the element can be directly formed on the other element, or intervening element(s) may also be present therebetween. In addition, it should be understood that the present invention may be embodied in different ways by those skilled in the art without departing from the scope of the present invention. Like components will be denoted by like reference numerals throughout the drawings.

Gas Barrier Film

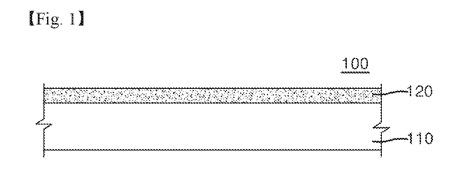

One aspect of the present invention relates to a gas barrier film. FIG. 1 is a sectional view of a gas barrier film according to the present invention. The gas barrier film 100 includes a substrate 110 and a barrier layer 120 formed on one surface of the substrate 110.

Although not particularly limited, a highly heat resistant plastic substrate having excellent heat resistance and low coefficient of thermal expansion may be used as the substrate 110. For example, the substrate may include at least one selected from the group consisting of polyethersulfone, polycarbonate, polyimide, polyether imide, polyacrylate, polyethylene naphthalate, and polyester films, without being limited thereto.

The substrate 110 may have a thickness of about 20 μm to about 250 μm, preferably about 70 μm to about 120 μm. Within this range, the substrate can exhibit excellent properties in terms of mechanical strength, flexibility, transparency, and heat resistance, suitable for use as a substrate of the gas barrier film.

The substrate 110 may further include inorganic fillers. The inorganic fillers may include, for example, at least one particle selected from the group consisting of silica, plate-shaped or spherical glass flakes, and nanoclay, or glass cloths. The substrate may have a coefficient of thermal expansion of about 10 ppm/° C. to about 100 ppm/° C.

The barrier layer 120 may be formed on one surface of the substrate 110. The barrier layer 120 may be formed as a silica (SiOx)-containing organic-inorganic or inorganic layer by coating a coating solution including hydrogenated polysiloxazane or polysilazane and an organic solvent onto one surface of the substrate 110, followed by drying and curing.

In the present invention, the organic-inorganic hybrid layer containing silica is formed by a process of applying the coating solution, followed by drying, curing, and high humidity aging. The process allows transformation into a ceramic material by transforming siloxane compounds contained in the coating solution, such as hydrogenated polysilazane or hydrogenated polysiloxazane, into silica (SiO₂).

The barrier layer may have a thickness of about 10 nm to 1,000 nm, specifically about 50 nm to 500 nm. Within this range, the barrier layer does not suffer from cracking and can provide excellent gas barrier performance.

In one embodiment, the gas barrier film may have a water vapor transmission rate of about 1 g/(m²·day) or less, as measured by the JIS K7129 B method.

In another embodiment, the gas barrier film may have a nitrogen (N) atom concentration in the barrier layer of about 1 at % to 6 at %. Within this range, it can be ensured that the barrier layer has high flexibility without deterioration in moisture absorption, thereby providing excellent crack prevention. The nitrogen atom concentration may be measured by Auger Electron Spectroscopy (AES).

Hereinafter, compositions of a coating solution for the barrier layer will be described in detail.

Coating Solution for Barrier Layer

A coating solution for the barrier layer containing silica may include hydrogenated polysiloxazane, hydrogenated polysilazane, or a mixture thereof; and a solvent. Details of each component of the coating solution are as follows:

(A) Hydrogenated Polysiloxazane or Hydrogenated Polysilazane

The coating solution is a composition for a silica layer and may include hydrogenated polysiloxazane, hydrogenated polysilazane, or a mixture thereof.

The hydrogenated polysiloxazane or the hydrogenated polysilazane is transformed into dense silica glass by heating and oxidation. The hydrogenated polysiloxazane includes a silicon-nitrogen (Si—N) bond unit and a silicon-oxygen-silicon (Si—O—Si) bond unit therein. The silicon-oxygen-silicon (Si—O—Si) bond unit can reduce shrinkage by relieving stress during curing. The hydrogenated polysilazane includes a silicon-nitrogen (Si—N) bond unit, a silicon-hydrogen (Si—H) bond unit, and a nitrogen-hydrogen (N—H) bond unit as a backbone. In both the hydrogenated polysiloxazane and the hydrogenated polysilazane, the (Si—N) bond can be substituted with a (Si—O) bond through baking or curing.

In one embodiment, the hydrogenated polysiloxazane has a unit represented by Formula 1, a unit represented by Formula 2, and a terminal group represented by Formula 3.

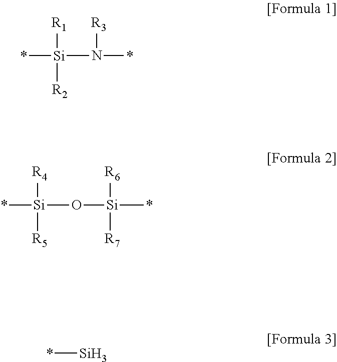

where R₁ to R₇ are each independently hydrogen, a substituted or unsubstituted C₁ to C₃₀ alkyl group, a substituted or unsubstituted C₃ to C₃₀ cycloalkyl group, a substituted or unsubstituted C₃ to C₃₀ aryl group, a substituted or unsubstituted C₃ to C₃₀ arylalkyl group, a substituted or unsubstituted C₃ to C₃₀ heteroalkyl group, a substituted or unsubstituted C₃ to C₃₀ heterocycloalkyl group, a substituted or unsubstituted C₃ to C₃₀ alkenyl group, a substituted or unsubstituted alkoxy group, a substituted or unsubstituted carbonyl group, a hydroxyl group, or combinations thereof.

As used herein, the term “substituted” means that at least one hydrogen atom is substituted with a halogen atom, a hydroxyl group, a nitro group, a cyano group, an amino group, an azido group, an amidino group, a hydrazino group, a carbonyl group, a carbamyl group, a thiol group, an ester group, a carboxyl group or a salt thereof, a sulfonic acid group or a salt thereof, a phosphate group or a salt thereof, a C₁ to C₂₀ alkyl group, a C₂ to C₂₀ alkenyl group, a C₂ to C₂₀ alkynyl group, a C₁ to C₂₀ alkoxy group, a C₆ to C₃₀ aryl group, a C₆ to C₃₀ aryloxy group, a C₃ to C₃₀ cycloalkyl group, a C₃ to C₃₀ cycloalkenyl group, a C₃ to C₃₀ cycloalkynyl group, or combinations thereof.

The hydrogenated polysiloxazane or the hydrogenated polysilazane may contain about 0.2 wt % to about 3 wt % of oxygen. Within this range, the hydrogenated polysiloxazane or the hydrogenated polysilazane can secure sufficient stress relief through the silicon-oxygen-silicon (Si—O—Si) bond in the structure thereof to prevent shrinkage of a cured product upon heat treatment, and the gas barrier layer can be prevented from suffering cracking. Specifically, the hydrogenated polysiloxazane or the hydrogenated polysilazane may contain about 0.2 wt % to about 3 wt % of oxygen, more specifically about 0.5 wt % to about 2 wt % of oxygen.

Further, the hydrogenated polysiloxazane or the hydrogenated polysilazane has a terminal group capped with hydrogen, and may include about 15 wt % to about 35 wt % of the terminal group represent by Formula 3 based on the total amount of the Si—H bonds in the hydrogenated polysiloxazane or the hydrogenated polysilazane. Within this range, the hydrogenated polysiloxazane or the hydrogenated polysilazane can prevent shrinkage of the cured product by preventing SiH₃ from being converted into SiH₄ and scattering while allowing sufficient oxidation upon curing, and the barrier layer can be prevented from suffering cracking. Preferably, the hydrogenated polysiloxazane or the hydrogenated polysilazane includes about 20 wt % to about 30 wt % of the terminal group represented by Formula 3 based on the total amount of the Si—H bonds in the hydrogenated polysiloxazane or the hydrogenated polysilazane.

The hydrogenated polysiloxazane or the hydrogenated polysilazane may have a weight average molecular weight (Mw) of about 1,000 g/mol to about 5,000 g/mol. Within this range, it is possible to reduce evaporation loss during heat treatment and to form a dense organic-inorganic hybrid layer by thin film coating. Preferably, the hydrogenated polysiloxazane or the hydrogenated polysilazane has a weight average molecular weight (Mw) of about 1,500 g/mol to about 3,500 g/mol.

The hydrogenated polysiloxazane, the hydrogenated polysilazane, or a mixture thereof may be present in an amount of about 0.1 wt % to about 50 wt % based on the total amount of the coating solution. Within this range, it is possible to maintain proper viscosity, whereby the organic-inorganic hybrid layer can be smoothly and uniformly formed without bubbling or voids.

(B) Solvent

The solvent may be selected from any solvent which does not react with the hydrogenated polysiloxazane or the hydrogenated polysilazane and can dissolve the hydrogenated polysiloxazane. Since a solvent containing —OH groups can react with a siloxane compound, a solvent containing no —OH group is preferably used as the solvent. For example, the solvent may include hydrocarbon solvents such as aliphatic hydrocarbons, alicyclic hydrocarbons, and aromatic hydrocarbons; halogenated hydrocarbon solvents; and ethers such as aliphatic ethers and alicyclic ethers. Specifically, the solvent may include hydrocarbons, such as pentane, hexane, cyclohexane, toluene, xylene, Solvesso, Taben; halogenated hydrocarbons, such as methylene chloride and trichloroethane; and ethers such as dibutyl ether, dioxane, and tetrahydrofuran. The solvent may be suitably selected in consideration of solubility of the siloxane compound or the evaporation rate of the solvent, and a mixture of these solvents may be used.

The coating solution may further include a thermal acid generator (TAG). The thermal acid generator is an additive for enhancing development of the hydrogenated polysiloxazane while preventing contamination due to the uncured hydrogenated polysiloxazane, and allows the hydrogenated polysiloxazane to be developed at a relatively low temperature. Although the thermal acid generator may be selected from any compound capable of generating hydrogen ions (H⁺) by heat, it is desirable that the thermal acid generator be selected from compounds capable of being activated at about 90° C. or more to generate sufficient hydrogen ions and exhibit low volatility. Examples of the thermal acid generator may include nitrobenzyl tosylate, nitrobenzyl benzene sulfonate, phenol sulfonate, and combinations thereof. The thermal acid generator may be present in an amount of about 25 wt % or less, for example, about 0.01 wt % to about 20 wt % based on the total amount of the coating solution. Within this range, the thermal acid generator enables development of the hydrogenated polysiloxazane at a relatively low temperature. Here, in order to provide superior gas barrier characteristics, the coating solution does not contain an organic component.

The coating solution may further include a surfactant. According to the present invention, any surfactant may be used without limitation, and examples of the surfactant may include nonionic surfactants, such as polyoxyethylene alkyl ethers including polyoxyethylene lauryl ether, polyoxyethylene stearyl ether, polyoxyethylene ether, polyoxyethylene oleyl ether, and the like, polyoxyethylene alkyl allyl ethers including polyoxyethylene nonylphenol ether, and the like, polyoxyethylene polyoxypropylene block copolymers, polyoxyethylene sorbitan fatty acid esters including sorbitan monolaurate, sorbitan monopalmitate, sorbitan monostearate, sorbitan monooleate, and the like; fluorine surfactants, such as F-Top EF301, EF303, EF352 (Tohchem Products Co., Ltd.), Megapack F171, F173 (Dainippon Ink & Chemicals Inc.), Fluorad FC430, FC431 (Sumitomo 3M Co., Ltd.); Asahi Guard AG710, Saffron S-382, SC101, SC102, SC103, SC104, SC105, SC106 (Asahi Glass Co., Ltd.), and the like; silicone surfactants, such as an organosiloxane polymer KP341 (Shin-Etsu Chemical Co., Ltd.), and the like. The surfactant may be present in an amount of about 10 wt % or less, for example, about 0.001 wt % to about 5 wt % based on the total amount of the coating solution. In order to provide further enhanced gas barrier performance, it is desirable that the surfactant include no organic component.

Method for Manufacturing Gas Barrier Film

A method for manufacturing a gas barrier film according to one embodiment of the present invention may include: (S1) coating the coating solution for a barrier layer as set forth above onto one surface of a substrate, (S2) drying, (S3) UV curing, and (S4) high humidity aging.

Coating (S1) may be achieved by coating the coating solution for a barrier layer onto one surface of the substrate by roll coating, spin coating, dip coating, bar coating, flow coating, or spray coating.

Drying (S2) is performed for leveling and prebaking. Although drying conditions are not particularly limited, drying may be performed at a temperature of higher than or equal to about 60° C. and less than a melting point of the substrate in consideration of realization of gas barrier properties and drying efficiency. For example, drying may be performed at 60° C. to 85° C. for about 1 to 5 minutes.

UV curing (S3) may be performed by, for example, vacuum UV treatment. Specifically, for vacuum UV irradiation, UV light at a wavelength of about 100 nm to about 200 nm may be used under vacuum conditions. In vacuum UV irradiation, irradiance and radiant exposure of UV light may be suitably adjusted. In one embodiment, vacuum UV irradiation may be performed at an irradiance of about 10 mW/cm² to about 200 mW/cm² and at a radiant exposure of about 100 mJ/cm² to about 6,000 mJ/cm², for example, about 1,000 mJ/cm² to about 5,000 mJ/cm².

High humidity aging (S4) is performed under a high humidity condition (RH of about 70% or higher) to provide a nitrogen (N) atom concentration in the barrier layer of about 1 at % to 6 at %, and secures excellent gas barrier performance while providing sufficient flexibility and crack resistance. For example, the high humidity condition may be a relative humidity (RH) of about 70% to 90%. High humidity aging (S4) may be performed at a low temperature of room temperature (20±10° C.) to about 90° C., for example, 60° C. to about 90° C. for about 10 to 60 minutes.

In another embodiment, the method for manufacturing a gas barrier film may further include heat treatment (S5) after high humidity aging (S4). When heat treatment is further performed, it is possible to enhance a degree of curing to reduce nitrogen concentration, thereby adjusting the nitrogen concentration in the barrier layer. However, when the nitrogen concentration in the barrier layer is decreased to less than 1%, the barrier layer can suffer from deterioration in flexibility and crack resistance, thereby causing deterioration in abrasion resistance and barrier performance. Thus, it is desirable that the nitrogen concentration be adjusted to range from 1 at % to 6 at %.

Heat treatment (S5) may be performed at about 150° C. or less, for example, about 100° C. to about 140° C. In addition, heat treatment may be performed for about 30 to 90 minutes, without being limited thereto. If necessary, high humidity aging time may be reduced and heat treatment time may be increased.

Flexible Display Including a Gas Barrier Film

By way of example, the gas barrier film may be suitably used in a flexible display. A flexible substrate, as a display substrate, is thinner, lighter, and more flexible than glass and can be processed in various forms. However, previously developed plastic substrates exhibit inferior properties to glass in terms of heat resistance, moisture and/or oxygen harrier performance and processability. The flexible display may include a plastic substrate; a gas barrier film for imparting moisture and/or oxygen barrier performance; and a planarization layer or a buffer layer for preventing cracking of the flexible substrate due to difference in property between the plastic substrate and the gas barrier film and improving flatness of the substrate.

### MODE FOR INVENTION

Hereinafter, the present invention will be described in more detail with reference to some examples. However, it should be understood that these examples are provided for illustration only and are not to be construed in any way as limiting the present invention. A description of details apparent to those skilled in the art will be omitted for clarity.

### Preparative Example 1

### Coating Solution I

Into a 2 L reactor provided with an agitator and a temperature controller, the inner atmosphere of which was previously replaced with dried nitrogen, a mixture obtained by sufficiently mixing 1,500 g of dried pyridine and 2.0 g of pure water was placed and maintained at 5° C. Then, 100 g of dichlorosilane was slowly introduced into the reactor for 1 hour, followed by stirring while slowly introducing 70 g of ammonia into the reactor over the course 3 hours. Thereafter, the reactor was purged with dried nitrogen for 30 minutes to remove residual ammonia from the reactor. The obtained product had a white slurry phase and was filtered under a dried nitrogen atmosphere using a Teflon membrane filter having a pore size of 1 μm, thereby obtaining 1,000 g of filtrate. After 1,000 g of dried xylene was added to the filtrate, an operation of substituting xylene for pyridine, as a solvent, was performed three times using a rotary evaporator to adjust a solid content to 20%, followed by filtration through a Teflon membrane filter having a pore size of 0.03 μm, thereby preparing a coating solution I.

The obtained hydrogenated polysiloxazane contained 0.5% of oxygen and had a SiH₃/SiH (total) value of 0.20 and a weight average molecular weight of 2,000 g/mol.

### Preparative Example 2

### Coating Solution II

25.62 g of tetraethyl silicate (TEOS, Sigma-Aldrich Corporation) was added to 100 g of distilled water with 0.3 g of 95% acetic acid mixed therewith, followed by stirring while adding methyltrimethoxysilane (MTMS) (KBM503, Shin-Etsu Chemical Co., Ltd.) at room temperature, thereby preparing a coating solution II as an organic/inorganic hybrid solution. Here, a mole ratio of tetraethyl silicate to methyltrimethoxysilane was 1:2.

### Examples 1 to 5

### Example 1

The coating solution I was coated on one surface of a 125 μm thick PEN film (TEONEX PQDA5, Teijin-Dupont Co., Ltd.) by spin coating. Spin coating was performed at 1,500 rpm for 20 seconds. Then, the coating layer was subjected to drying in a convection oven at 80° C. for 3 minutes, followed by curing through UV irradiation at a radiant exposure of 2,000 mJ/cm² using a vacuum UV irradiator (Model CR403, SMT Co., Ltd.). Then, the cured coating layer was subjected to high humidity aging in a constant temperature and humidity chamber at 85° C. and 85% RH for 30 minutes, thereby forming a 500 nm thick barrier layer. The prepared gas barrier film was evaluated as to the following properties and results are shown in Table 1.

### Example 2

The coating solution I was coated on one surface of a 125 μm thick PEN film (TEONEX PQDA5, Teijin-Dupont Co., Ltd.) by spin coating. Spin coating was performed at 1,500 rpm for 20 seconds. Then, the coating layer was subjected to drying in a convection oven at 80° C. for 3 minutes, followed by curing through UV irradiation at a radiant exposure of 2,000 mJ/cm² using a vacuum UV irradiator (Model CR403, SMT Co., Ltd.). Then, the cured coating layer was subjected to heat treatment in a convection oven at 120° C. for 1 hour, followed by high humidity aging in a constant temperature and humidity chamber at 85° C. and 60% RH for 10 minutes, thereby forming a 500 nm thick barrier layer. The prepared gas barrier film was evaluated as to the following properties and results are shown in Table 1.

### Example 3

The coating solution I was coated on one surface of a 125 μm thick PEN film (TEONEX PQDA5, Teijin-Dupont Co., Ltd.) by spin coating. Spin coating was performed at 1,500 rpm for 20 seconds. Then, the coating layer was subjected to drying in a convection oven at 80° C. for 3 minutes, followed by curing through UV irradiation at a radiant exposure of 4,000 mJ/cm² using a vacuum UV irradiator (Model CR403, SMT Co., Ltd.). Then, the cured coating layer was subjected to high humidity aging in a constant temperature and humidity chamber at 85° C. and 60% RH for 10 minutes, thereby forming a 500 nm thick barrier layer. The prepared gas barrier film was evaluated as to the following properties and results are shown in Table 1.

### Example 4

The coating solution I was coated on one surface of a 125 μm thick PEN film (TEONEX PQDA5, Teijin-Dupont Co., Ltd.) by spin coating. Spin coating was performed at 1,500 rpm for 20 seconds. Then, the coating layer was subjected to drying in a convection oven at 80° C. for 3 minutes, followed by curing through UV irradiation at a radiant exposure of 2,000 mJ/cm² using a vacuum UV irradiator (Model CR403, SMT Co., Ltd.). Then, the cured coating layer was subjected to high humidity aging in a constant temperature and humidity chamber at 85° C. and 60% RH for 20 minutes, thereby forming a 500 nm thick barrier layer. The prepared gas barrier film was evaluated as to the following properties and results are shown in Table 1.

### Example 5

The coating solution I was coated on one surface of a 125 μm thick PEN film (TEONEX PQDA5, Teijin-Dupont Co., Ltd.) by spin coating. Spin coating was performed at 1,500 rpm for 20 seconds. Then, the coating layer was subjected to drying in a convection oven at 80° C. for 3 minutes, followed by curing through UV irradiation at a radiant exposure of 2,000 mJ/cm² using a vacuum UV irradiator (Model CR403, SMT Co., Ltd.). Then, the cured coating layer was subjected to high humidity aging in a constant temperature and humidity chamber at 85° C. and 60% RH for 10 minutes, thereby forming a 500 nm thick barrier layer. The prepared gas barrier film was evaluated as to the following properties and results are shown in Table 1.

### Comparative Examples 1 to 4

### Comparative Example 1

The coating solution I was coated on one surface of a 125 μm thick PEN film (TEONEX PQDA5, Teijin-Dupont Co., Ltd.) by spin coating. Spin coating was performed at 1,500 rpm for 20 seconds. Then, the coating layer was subjected to drying in a convection oven at 80° C. for 3 minutes, followed by heat treatment in a convection oven at 120° C. for 1 hour, thereby forming a 500 nm thick barrier layer. The prepared gas barrier film was evaluated as to the following properties and results are shown in Table 1.

### Comparative Example 2

The coating solution I was coated on one surface of a 125 μm thick PEN film (TEONEX PQDA5, Teijin-Dupont Co., Ltd.) by spin coating. Spin coating was performed at 1,500 rpm for 20 seconds. Then, the coating layer was subjected to drying in a convection oven at 80° C. for 3 minutes, followed by curing through UV irradiation at a radiant exposure of 2,000 mJ/cm² using a vacuum UV irradiator, thereby forming a 500 nm thick barrier layer. The prepared gas barrier film was evaluated as to the following properties and results are shown in Table 1.

### Comparative Example 3

The coating solution II was coated on one surface of a 125 μm thick PEN film (TEONEX PQDA5, Teijin-Dupont Co., Ltd.) by spin coating. Spin coating was performed at 1,500 rpm for 20 seconds. Then, the coating layer was subjected to drying in a convection oven at 80° C. for 3 minutes, followed by curing through UV irradiation at a radiant exposure of 2,000 mJ/cm² using a vacuum UV irradiator (Model CR403, SMT Co., Ltd.). Then, the cured coating layer was subjected to heat treatment in a convection oven at 120° C. for 1 hour, followed by high humidity aging in a constant temperature and humidity chamber at 85° C. and 60% RH for 10 minutes, thereby forming a 500 nm thick barrier layer. The prepared gas barrier film was evaluated as to the following properties and results are shown in Table 1.

### Comparative Example 4

The coating solution I was coated on one surface of a 125 μm thick PEN film (TEONEX PQDA5, Teijin-Dupont Co., Ltd.) by spin coating. Spin coating was performed at 1,500 rpm for 20 seconds. Then, the coating layer was subjected to drying in a convection oven at 80° C. for 3 minutes, followed by curing through UV irradiation at a radiant exposure of 4,000 mJ/cm² using a vacuum UV irradiator (Model CR403, SMT Co., Ltd.). Then, the cured coating layer was subjected to heat treatment in a convection oven at 120° C. for 1 hour, followed by high humidity aging in a constant temperature and humidity chamber at 85° C. and 85% RH for 20 minutes, thereby forming a 500 nm thick barrier layer. The prepared gas barrier film was evaluated as to the following properties and results are shown in Table 1.

Evaluation of Properties

Nitrogen Atom Concentration (Atomic Percent):

Amount of nitrogen in the barrier layer was measured by Auger Electron Spectroscopy (AES).

Abrasion Resistance (ΔH):

The gas barrier film was rubbed back and forth over 100 mm 20 times under a load of 1,000 kg/cm² at a rate of 50 mm/sec using a scratch resistance tester (HEIDON, Shinto Scientific). Haze before/after rubbing was measured using a hazemeter.

Water Vapor Transmission Rate (WVTR) (g/(m²·day)):

Water vapor transmission rate was measured at 38° C. and 100% RH using a water vapor transmission rate tester (PERMATRAN-W 3/31, MOCON Co., Ltd., US) in accordance with method B (IR sensor method) described in JIS K7129 (edited in 2000). For each of Examples and Comparative Examples, two specimens were prepared. Measurements for the specimens were averaged.

Cracking:

After each of the gas barrier films prepared in Examples and Comparative examples was left at room temperature for 1 hour, cracking of the gas barrier film was checked with the naked eye. Evaluation was conducted according to three-graded criteria as follows, and results are shown in Table 1.

Good (designated by x in Table 1): No cracking was observed.

Normal (designated by Δ in Table 1): Cracking was partially observed in the coating layer.

Poor (designated by ◯ in Table 1): Cracking was observed throughout the coating layer.

Adhesion (Number/Number):

A tape was attached to each specimen formed therein to be cut into 100 sections each having a size of 2 mm×2 mm, and then strongly pulled once in a vertical direction, followed by counting the number of remaining sections. Results are shown in Table 1.

TABLE 1

| | | Example | Example | Example | Example | Example | Comp. | Comp. | Comp. | Comp. |
|---|---|---|---|---|---|---|---|---|---|---|
| Item | | 1 | 2 | 3 | 4 | 5 | Example 1 | Example 2 | Example 3 | Example 4 |
| Thickness | Coating | 500 | 500 | 500 | 500 | 500 | 500 | 500 | — | 500 |
| of barrier | solution I | | | | | | | | | |
| layer (nm) | Coating | | — | — | — | — | — | — | 500 | — |
| | solution II | | | | | | | | | |
| UV curing | | 2000 mJ/ | 2000 mJ/ | 4000 mJ/ | 2000 mJ/ | 2000 mJ/ | — | 2000 mJ/ | 2000 mJ/ | 4000 mJ/ |
| | | cm² | cm² | cm² | cm² | cm² | | cm² | cm² | cm² |
| High humidity aging | | 85° C./85% | 85° C./60% | 85° C./60% | 85° C./60% | 85° C./60% | — | — | 85° C./60% | 85° C./85% |
| | | (30 min) | (10 min) | (10 min) | (20 min) | (10 min) | | | (10 min) | (20 min) |
| Heat treatment | | — | 120° C., | — | — | — | 120° C., | — | 120° C., | 120° C., |
| | | | 1 hr | | | | 1 hr | | 1 hr | 1 hr |
| N atom concentration | | 1 | 1 | 2 | 4 | 6 | 20 | 10 | 0 | 0.5 |
| (%) | | | | | | | | | | |
| Haze (%) | Before | 0.4 | 0.4 | 0.4 | 0.4 | 0.4 | 0.4 | 0.4 | 0.4 | 0.4 |
| | rubbing | | | | | | | | | |
| | After | 0.4 | 0.4 | 0.4 | 0.4 | 0.4 | 25.0 | 7.8 | 21.6 | 1.8 |
| | rubbing | | | | | | | | | |
| | ΔH | 0 | 0 | 0 | 0 | 0 | 24.6 | 7.4 | 20.2 | 1.4 |

| | | | | | | | | | |
|---|---|---|---|---|---|---|---|---|---|
| WVTR (g/m²/day) | 0.02 | 0.02 | 0.06 | 0.03 | 0.03 | 1.45 | 1.38 | 1.44 | 0.3 |
| Cracking | X | X | X | X | X | X | X | X | Δ |
| Adhesion | 100/ | 100/ | 100/ | 100/ | 100/ | 0/ | 50/ | 100/ | 80/ |
| | 100 | 100 | 100 | 100 | 100 | 100 | 100 | 100 | 100 |

As shown in Table 1, it can be seen that the barrier films of Examples 1 to 5 manufactured by coating the coating solution I including hydrogenated polysiloxazane, followed by UV curing and high humidity aging had a nitrogen atom concentration in the barrier layer of 1 at % to 6 at % and exhibited excellent properties in terms of scratch resistance, barrier performance, crack prevention, and adhesion.

On the contrary, the barrier film of Comparative Example 1 only subjected to heat treatment without undergoing UV curing and high humidity aging had an excessively high nitrogen atom concentration in the barrier layer and thus exhibited very poor properties in terms of barrier performance, abrasion resistance, and adhesion. The barrier film of Comparative Example 2 not undergoing high humidity aging had a nitrogen atom concentration in the barrier layer of higher than 6% and thus exhibited poor properties in terms of barrier performance, abrasion resistance, and adhesion. The barrier film of Comparative Example 3 manufactured using the coating solution II not including hydrogenated polysiloxazane or hydrogenated polysilazane had no nitrogen in the barrier layer despite UV curing and high humidity aging and exhibited very poor scratch resistance and barrier performance. In addition, the barrier film of Comparative Example 4 had a nitrogen atom concentration in the barrier layer of less than 1%, which means that the barrier film was excessively cured. Thus, the barrier film of Comparative Example 4 exhibited poor crack resistance and flexibility and thus poor barrier performance.

1. A gas barrier film comprising a substrate; and a barrier layer formed on the substrate, wherein the barrier layer has a nitrogen (N) atom concentration of about 1 at % to about 6 at %.

2. The gas barrier film according to claim 1, wherein the gas barrier film has a difference in haze (ΔHaze) before/after rubbing of about 5% or less, where the gas barrier film is rubbed back and forth over 100 mm 20 times under a load of 1,000 kg/cm² at a rate of 50 mm/sec using a scratch resistance tester (HEIDON, Shinto Scientific).

3. The gas barrier film according to claim 1, wherein the gas barrier film has a water vapor transmission rate of about 1 g/(m²·day) or less, as measured by the JIS K7129 B method.

4. The gas barrier film according to claim 1, wherein the barrier layer originates from hydrogenated polysiloxazane or hydrogenated polysilazane.

5. The gas barrier film according to claim 1, wherein the substrate has a thickness of about 20 μm to about 250 μm, and the barrier layer has a thickness of about 10 nm to about 1,000 nm.

6. A method for manufacturing a gas barrier film, comprising:
coating a coating solution comprising hydrogenated polysilazane or hydrogenated polysiloxazane onto one surface of a substrate,
UV curing, and
high humidity aging at about 70% to about 90% RH to form a barrier layer having a nitrogen atom concentration of about 1 at % to about 6 at %.

7. The method according to claim 6, further comprising: heat treatment at about 100° C. to about 140° C. for about 30 to about 90 minutes, after UV curing.

8. The method according to claim 6, wherein high humidity aging is performed at about 60° C. to about 90° C. for about 10 to about 60 minutes.

9. The method according to claim 6, wherein coating is performed by roll coating, spin coating, dip coating, bar coating, flow coating, or spray coating.

10. The method according to claim 6, wherein UV curing is performed at an irradiance of about 10 mW/cm² to about 200 mW/cm² and at a radiant exposure of about 100 mJ/cm² to about 6,000 mJ/cm².

11. The method according to claim 6, wherein hydrogenated polysiloxazane contains about 0.2 wt % to about 3 wt % of oxygen.

12. A flexible display having the gas barrier film according to claim 1 formed on a flexible substrate.
